(19) United States
(12) Patent Application Publication
(10) Pub. No.: US 2002/0030143 A1
(43) Pub. Date: Mar. 14, 2002

(54) Stackable cable tray apparatus

(76) Inventor: Roger Jette, West Islip, NY (US)

Correspondence Address: Raymond E. Farrell, DILWORTH & BARRESE, LLP, 333 Earle Ovington Blvd., Uniondale, NY, 11553, US

(21) Appl. No.: 09/918,272

(22) Filed: Jul. 30, 2001

Related U.S. Application Data
(60) Provisional application No. 60/221,322, filed on Jul. 28, 2000.

(51) Int. Cl. F16L 3/00

(52) U.S. Cl. 248/49

(57) ABSTRACT

A stackable cable tray apparatus, including a cable tray channel section having a plurality of transverse elements, each transverse element having a horizontal portion and a riser portion disposed on either end thereof, the riser portion being disposed at an included angle which is greater than 90 degrees relative to the horizontal portion, and a plurality of longitudinal elements interconnecting each of said plurality of transverse and riser elements, the plurality of transverse elements, the plurality of riser elements and the plurality of longitudinal elements defining an open ended pathway for receiving cables therein and whereby a plurality of cable tray channel sections are nestable one within the other.

### CROSS REFERENCE TO RELATED APPLICATIONS

The present application claims priority of U.S. provisional application Serial No. 60/221,322 filed on Jul. 28, 2000, the entire contents of which are hereby incorporated by reference.

### BACKGROUND

1. Technical Field

The present disclosure relates to an apparatus for supporting cables. More particularly, the present disclosure relates to a stackable cable tray apparatus that can be structurally supported from a wall, ceiling, or a raised floor system.

2. Description of Related Art

Many currently available cable management systems are made up of a number of individual units which are joined together to form the actual cable management system itself. However, when the cable management system is taken apart or more specifically before the cable management system is assembled, the individual units making up the system to the extent they are stackable at all, are not able to be fitted together in such a way that is economical to store, package and ship. In other words, each individual unit generally takes up a certain amount of space/volume and is incapable of being efficiently fitted with another individual unit in such a way so as to reduce the overall space/volume required to store, package and ship multiple units.

A typical cable management system installation may require anywhere from a few to a few hundred individual cable trays or cable baskets as needed. As a result, a large supply of trays and baskets are required in order to meet the needs of a particular installation. Thus, in order to reduce the costs of storing such a large quantity of units or to reduce the material costs associated with packaging such units or to reduce the cost of shipping a potentially large volume of such materials, a need exists for a cable tray apparatus which is efficiently stackable.

### SUMMARY OF THE INVENTION

The presently disclosed stackable cable tray apparatus overcomes the disadvantages of previous cable tray designs by providing a stackable cable tray apparatus which enables greater quantities of individual sections to be warehoused in a much smaller area than traditional non-stackable cable systems.

Further, the present disclosure provides a stackable cable tray apparatus which reduces the cost of warehousing a section of the cable tray apparatus on a per section basis.

The presently disclosed stackable cable tray apparatus is designed to allow for individual units/sections of the apparatus to be stacked or nested, one atop another or one within another, to minimize packaging and shipping materials and reduce freight and packaging labor costs while the apparatus is being stored or shipped. The stackable cable tray apparatus includes at least one cable tray channel section having a plurality of transverse elements with each transverse element having a riser element disposed on either end thereof, and a plurality of longitudinal elements interconnecting each of said plurality of transverse and riser elements; the plurality of transverse elements, the plurality of riser elements and the plurality of longitudinal elements defining an open ended pathway for receiving cables therein. In this way, the costs associated with storing, shipping and packaging of a cable tray apparatus are reduced.

A stackable cable tray apparatus is provided, which apparatus includes a cable tray channel section having a plurality of transverse elements, each transverse element having a horizontal portion and a riser portion disposed on either end thereof, the riser portion being disposed at an included angle which is greater than 90 degrees relative to the horizontal portion, and a plurality of longitudinal elements interconnecting each of the plurality of transverse and riser elements, the plurality of transverse elements, the plurality of riser elements and the plurality of longitudinal elements defining an open ended pathway for receiving cables therein and whereby a plurality of cable tray channel sections are nestable one within the other.

In a further embodiment, the present disclosure provides a stackable cable tray apparatus, which apparatus includes a stackable cable tray channel section made up of a plurality of longitudinal elements and a plurality of transverse elements interconnecting the longitudinal elements, wherein the transverse elements include first riser portions and second riser portions; and hanging means structured and arranged such that the channel section is affixed via an attachment point to a supporting structure.

### BRIEF DESCRIPTION OF THE DRAWINGS

Preferred embodiments of the presently disclosed raised floor system and cable support assembly are described herein with reference to the drawings, wherein:

FIG. 1 is a perspective view showing one embodiment of a stackable cable tray apparatus constructed in accordance with the present disclosure and shown installed by suspension from a ceiling;

FIG. 2 is an end view of an alternative support structure configuration of the stackable cable tray apparatus embodiment of FIG. 1;

FIG. 3A is a longitudinal view of the stackable cable tray apparatus showing an attachment mechanism for two stackable cable tray sections;

FIG. 3B is an enlarged perspective longitudinal view of one configuration of an attachment mechanism for connecting two stackable cable tray sections together; and

FIG. 4 is a frontal transverse view of two stackable cable tray sections nested together in position for shipment or storage.

### DETAILED DESCRIPTION OF PREFERRED EMBODIMENTS

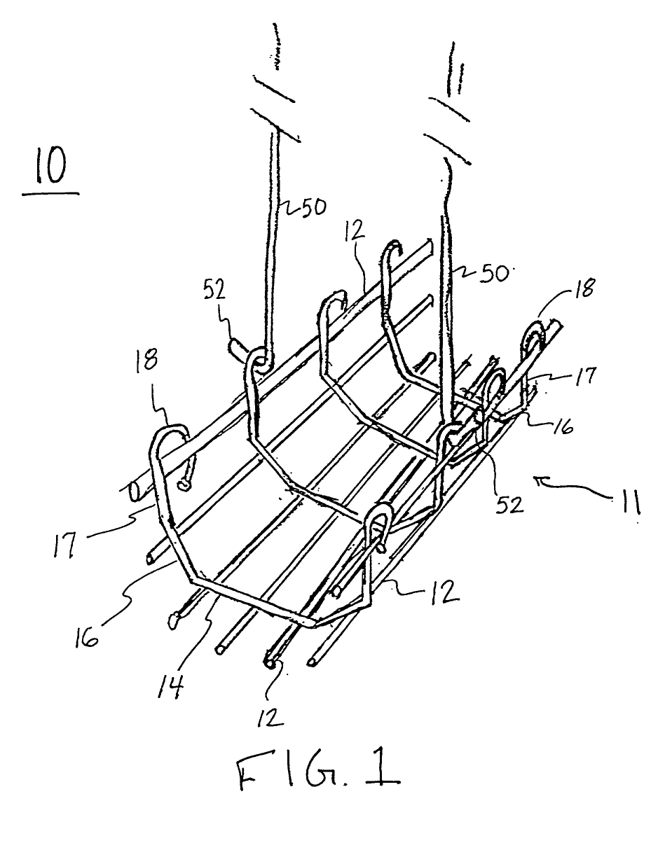

Referring now in specific detail to the drawings in which like reference numerals identify similar or identical elements throughout the several views, and initially to FIG. 1, an illustrative example of the presently disclosed cable tray apparatus 1 0 is shown installed suspended vertically from a ceiling. Cable tray apparatus 10 is formed in stackable cable tray channel sections 11 of a predetermined length, for example, four, six or eight foot sections, from wire stock having longitudinal elements 12 attached to horizontal transverse elements 14, by suitable attachment techniques, for example, welding.

Transverse elements 14 include a first transverse riser portion 16 and a second transverse riser portion 17 defining a substantially U-shaped profile. In one embodiment, the second transverse riser portions 17 are substantially orthogonal relative to the transverse element 14. In an alternative embodiment, the distal ends of a pair of second transverse riser portions 17 extending from a common transverse element 14 are spaced a distance apart which is greater than or equal to the length of the transverse element. Typically, the first transverse riser portion 16 is disposed at an included angle which is greater than 90 degrees relative to the transverse elements 14.

Mounting terminals such as eye portions 18 are formed at the ends of each transverse second riser portion 17 and form attachment points for hooks 52 of rods 50, or any similar attachment mechanism. For example, rod 50 can be mounted such that rod 50 depends from a ceiling, depends vertically from a bracket on a wall, or extends diagonally from a wall. The quantity of rods 50 necessary to support individual channel sections 11 varies with the load and load bearing configuration of cable tray apparatus 10. Longitudinal elements 12 and transverse elements 14 are structurally joined using resistance welding, or a similar method, to form a rigid structure that provides adequate support for utility loads. The quantity of transverse elements 14, 16, 17 and longitudinal elements 12 in a given configuration of cable tray apparatus 10 is a function of its load bearing and individual application. The wire stock used to form cable tray apparatus 10 is preferably configured to preclude any sharp edges thereby reducing the risk of damaging cables upon installation or removal from the tray.

Eyes 18, transverse second riser portions 17, transverse first riser portions 16, transverse elements 14 and longitudinal elements 12 collectively define an open ended pathway 15 that runs the length of channel section 11. The width of transverse element 14 is less than the width of the open end of pathway 15. While cable tray apparatus 10 is shown having a semi-hexagon type transverse cross-section, additional transverse cross-sectional geometries such as a semi-circle, triangle, or semi-octagon, for example, are also envisioned as alternative embodiments which would also facilitate the stackable nesting feature of channel sections 11.

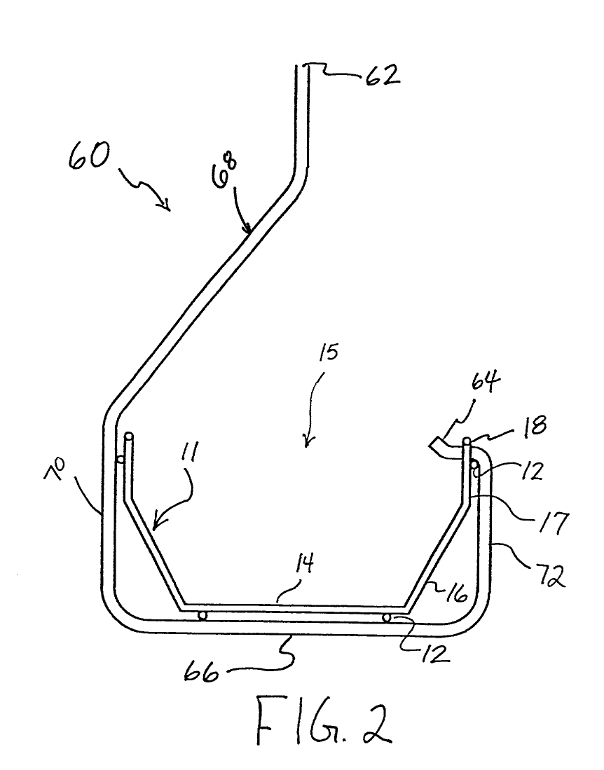

In FIG. 2, an alternative supporting structure, such as hanger 60, is shown that forms a support structure under channel sections 11 and requires only a single attachment point 62 to a ceiling or wall bracket, for example. Preferably attachment point 62 is aligned with the center line of channel section 11 so that when loaded with cables, the weight will be evenly distributed. Hanger 60 includes a hanger support member 68 integrally formed with a rear wall member 70, which is integrally formed with a base support surface portion 66 which is integral with a front wall member 72. The front wall member 72 includes a hook 64 formed at a distal end thereof. In use, channel sections 11 are positioned within the hanger 60 by placing hook 64 within eye 18 while placing channel section 11 on support structure portion 66.

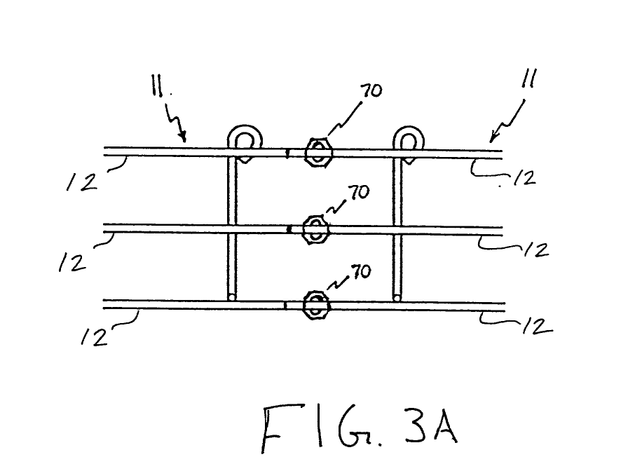

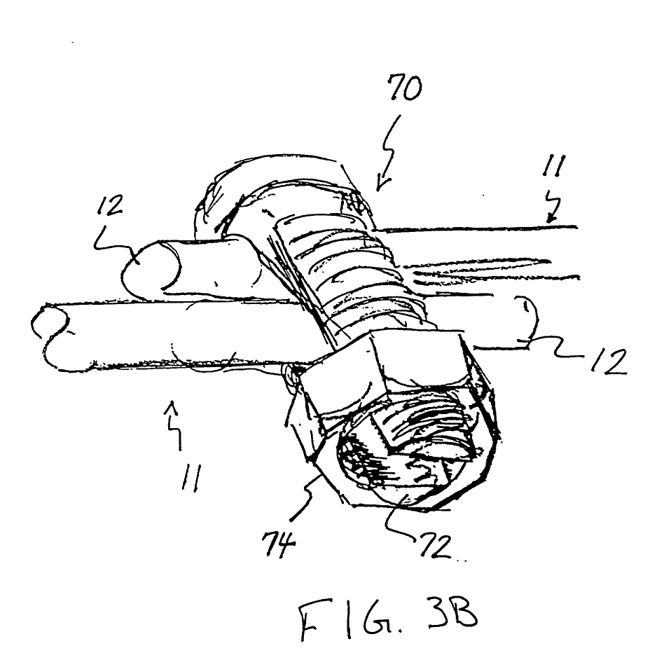

In FIG. 3A, two adjacent channel sections 11 are shown connected together with attachment mechanisms 70 wherein longitudinal elements 12 from a first channel section 11 overlap longitudinal elements 12 of a second adjacent channel section 11. Cable tray channel sections 11 can be formed in any geometry of bends that are vertical, horizontal, or combinations thereof. Similarly, channel sections 11 can be formed in a variety of standard and non-standard lengths, widths, and load bearing capacities.

In FIG. 3B, longitudinal elements 12 from two adjacent channel sections 11 are shown joined together using a commercially available attachment mechanism 70, such as a CB-10 connector. The CB-10 connector includes a bolt with a split threaded rod 72 in combination with a nut 74, for example, to facilitate grounding and bonding between overlapping longitudinal elements 12 of channel sections 11. In use, an end of a longitudinal element 12 from a first channel section 11 and an end of a longitudinal element 12 from an adjacent channel section 11 are inserted within the split end of the threaded rod 72 and the nut 74 is then secured to the threaded rod 72.

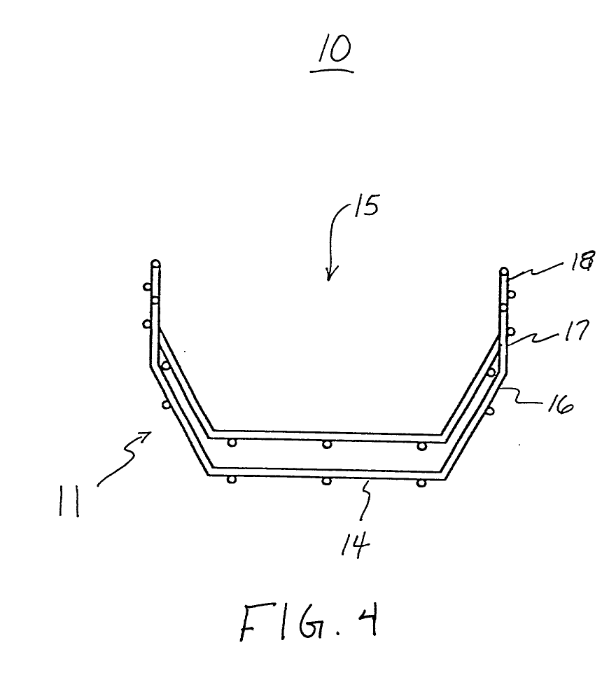

Referring now to FIG. 4, the manner in which multiple stackable cable tray apparatus sections 10 are nested together for shipment is shown. The angle of transverse riser portions 16, which results in the open end of pathway 15 being larger than the width of transverse element 14, facilitates stacking of multiple cable tray apparatus sections 10 in nesting fashion. Further, this uniquely advantageous construction permits nested stacking of channel sections 11 without having to horizontally offset adjacent sections. Thus, much greater numbers of channel sections 11 can be nested to form a uniform stack. The angle of the transverse riser portions 16 creates a wider open end of pathway 15 having a geometric configuration that is capable of accommodating a second channel section 11 between the first riser portions 16 and second riser portions 17. This frontal transverse profile also emphasizes the ability of the stackable cable tray apparatus 10 to keep cables centrally loaded on transverse section 14 and yet still maintain the ability to gain easy access to individual cables within the tray when required. The ability to nest stackable channel sections 11 minimizes packaging and shipping materials and reduces packaging labor costs for cable tray apparatus 10. Additionally, the stackable feature enables greater quantities of channel sections 11 to be warehoused in a much smaller area than traditional non-nestable cable trays. Thus, reducing the cost of warehousing the cable tray channel sections on a per section basis.

Although the illustrative embodiments of the present disclosure have been described herein with reference to the accompanying drawings, it is to be understood that the disclosure is not limited to those precise embodiments, and that various other changes and modifications may be affected therein by one skilled in the art without departing from the scope or spirit of the disclosure. All such changes and modifications are intended to be included within the scope of the appended claims.

What is claimed is:

1. A stackable cable tray apparatus, comprising:
a cable tray channel section having;
a plurality of transverse elements, each transverse element having a horizontal portion and a riser portion disposed on either end thereof, the riser portion being disposed at an included angle which is greater than 90 degrees relative to the horizontal portion, and
a plurality of longitudinal elements interconnecting each of said plurality of transverse and riser elements;
said plurality of transverse elements, said plurality of riser elements and said plurality of longitudinal elements defining an open ended pathway for receiving cables therein.

2. The stackable cable tray apparatus according to claim 1, wherein said transverse elements each include second riser portions disposed substantially orthogonal with respect to said horizontal portion of said transverse element.

3. The stackable cable tray apparatus according to claim 1, further comprising a mounting terminal formed at an end of each riser element.

4. The stackable cable tray apparatus according to claim 3, further comprising an attachment mechanism for mounting said cable tray apparatus to a support structure.

5. The stackable cable tray apparatus according to claim 4, wherein said attachment mechanism includes a plurality of rods each having a hooking means formed at an end thereof, said hooking means being structured for receiving said eyelet thereon and for carrying said cable tray.

6. The stackable cable tray apparatus according to claim 4, wherein said attachment mechanism includes a hanger having a hanger support member integrally formed with a base support surface portion which is integral with a front wall portion, and a hook formed at a distal end of said front wall, whereby said channel sections are positioned within said hanger by inserting said hook into said mounting terminal and placing said channel section onto said base support member, wherein said hanger support element is substantially located along a center of gravity of said stackable cable tray apparatus.

7. The stackable cable tray apparatus according to claim 1, wherein each of said plurality of longitudinal elements are affixed to a side of said plurality of transverse elements and said plurality of riser portions exterior of said open ended pathway.

8. The stackable cable tray apparatus according to claim 1, which includes a plurality of said cable tray channel sections stackable one on top of the other in nested fashion.

9. The stackable cable tray apparatus according to claim 8, further comprising an attachment mechanism for coupling adjacent cable tray channel sections together upon assembly thereof.

10. The stackable cable tray apparatus according to claim 9, wherein said attachment mechanism includes a bolt having a split threaded rod, and a nut, whereby a distal end of a first longitudinal element and a proximal end of a second longitudinal element are placed within said split threaded rod and said nut is secured to said split threaded rod thereby securing said first and second longitudinal elements to one another.

11. The stackable cable tray apparatus according to claim 1, wherein the cable tray channel sections are configured and dimensioned to be nested one inside the other without requiring substantial horizontal shifting of adjacent cable tray channel sections, thereby forming a substantially uniform stack of cable tray channel sections.

12. A stackable cable tray apparatus, comprising a plurality of cable tray channel sections each defining an open ended pathway, the open ended pathway being wider at an open end thereof and narrower at a closed end thereof, wherein each cable tray channel section is structured and arranged to be nested within another cable tray channel section.

13. The stackable cable tray apparatus according to claim 12, wherein the cable tray channel sections are configured and dimensioned to be nested one inside the other without requiring substantial horizontal shifting of adjacent cable tray channel sections, thereby forming a substantially uniform stack of cable tray channel sections.
